(19) United States
(12) Patent Application Publication
(10) Pub. No.: US 2026/0340350 A1
(43) Pub. Date: Oct. 29, 2026

(54) LEARNING CAPABLE AI AGENTS

(71) Applicant: Cisco Technology, Inc., San Jose, CA (US)

(72) Inventors: Andrea Morandi, Greenbrae, CA (US); Mahesh Viswanathan, White Plains, NY (US); Saurabh Gupta, Bellevue, WA (US)

(73) Assignee: Cisco Technology, Inc., San Jose, CA (US)

(21) Appl. No.: 19/191,215

(22) Filed: Apr. 28, 2025

(51) Int. Cl. G06N 3/0455

(52) U.S. Cl. CPC G06N 3/0455

(57) ABSTRACT

In one implementation, a device distills raw data regarding a past experience of an agentic system completing a first task into distilled experience data, the agentic system comprising a plurality of artificial intelligence-based agents that cooperated to complete the first task. The device receives a request for the agentic system to perform a second task. The device retrieves the distilled experience data and the raw data regarding the past experience in part by performing a matching of the second task to the distilled experience data. The device provides the distilled experience data and the raw data regarding the past experience to the agentic system for use to complete the second task.

### TECHNICAL FIELD

The present disclosure relates generally to artificial intelligence and, more particularly, to learning capable artificial intelligence (AI) agents.

### BACKGROUND

The recent breakthroughs in large language models (LLMs) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

Current LLM- and other AI-based agents demonstrate impressive problem-solving capabilities through multi-step reasoning and research. However, AI models such as LLMs are also stateless and lack learning abilities. This means they cannot utilize past experiences to improve their present and future performance. As a result, they repetitively undergo the same lengthy processes for solving similar problems. To address this, modern approaches rely on using supervised fine-tuning or reinforcement learning to learn specific question-solution pairs, thereby allowing the model to generate direct answers to those questions. While this can be effective for tasks with clear rules, it also 1.) reduces the ability of the model to generalize to new situations, 2.) has a high resource consumption due to its complexity (e.g., in terms of time, computing resources, etc.), 3.) requires large amounts of training examples, and 4.) risks catastrophic forgetting whereby the model forgets previously learned knowledge when new data is introduced.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example architecture for learning capable AI agents;

FIG. 6 illustrates an example code snippet

FIGS. 7A-7B illustrate examples of generated images;

FIG. 8 illustrates an example architecture for code generation and review; and

FIG. 9 illustrates an example simplified procedure for using learning capable artificial intelligence (AI) agents, in accordance with one or more implementations described herein.

### DESCRIPTION OF EXAMPLE IMPLEMENTATIONS

### Overview

According to one or more implementations of the disclosure, a device distills raw data regarding a past experience of an agentic system completing a first task into distilled experience data, the agentic system comprising a plurality of artificial intelligence-based agents that cooperated to complete the first task. The device receives a request for the agentic system to perform a second task. The device retrieves the distilled experience data and the raw data regarding the past experience in part by performing a matching of the second task to the distilled experience data. The device provides the distilled experience data and the raw data regarding the past experience to the agentic system for use to complete the second task.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

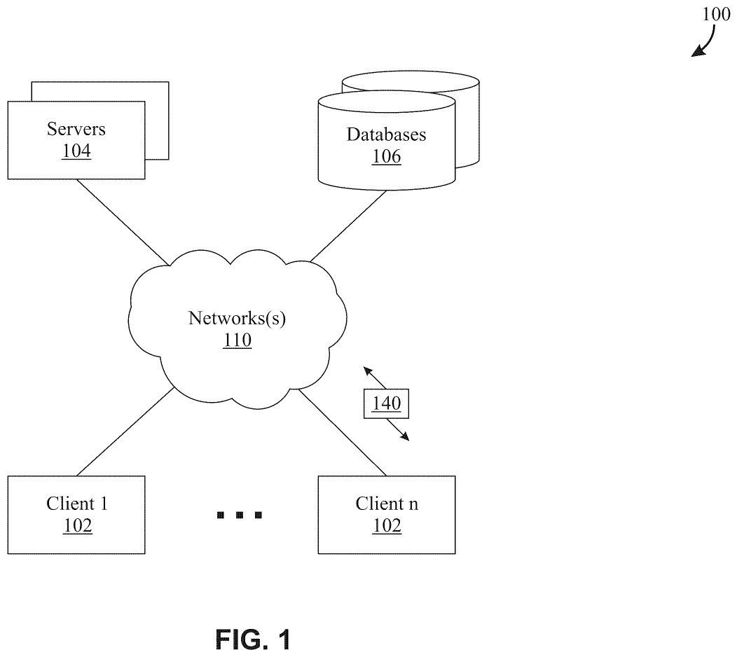

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

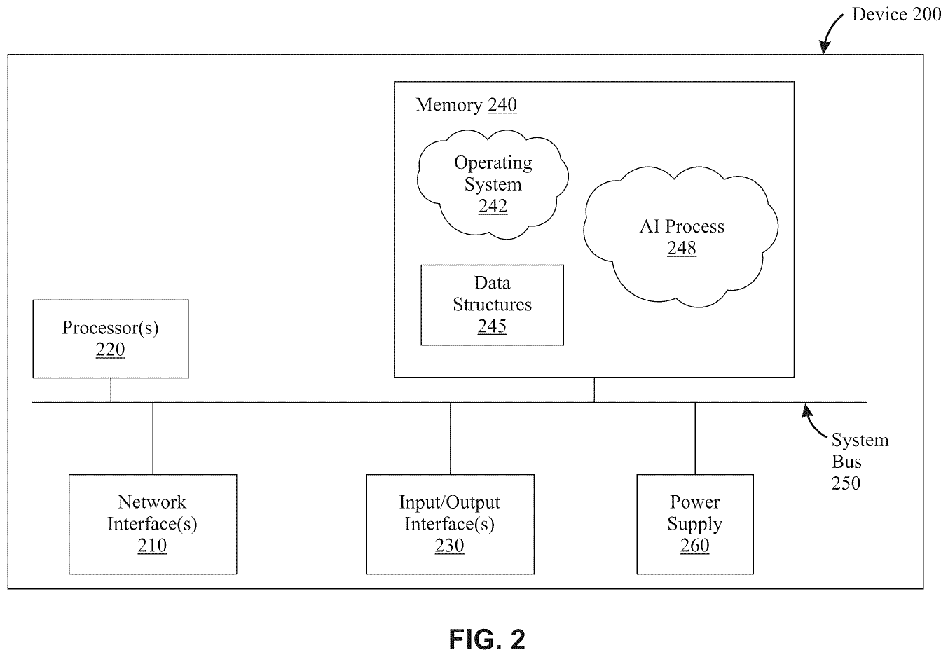

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

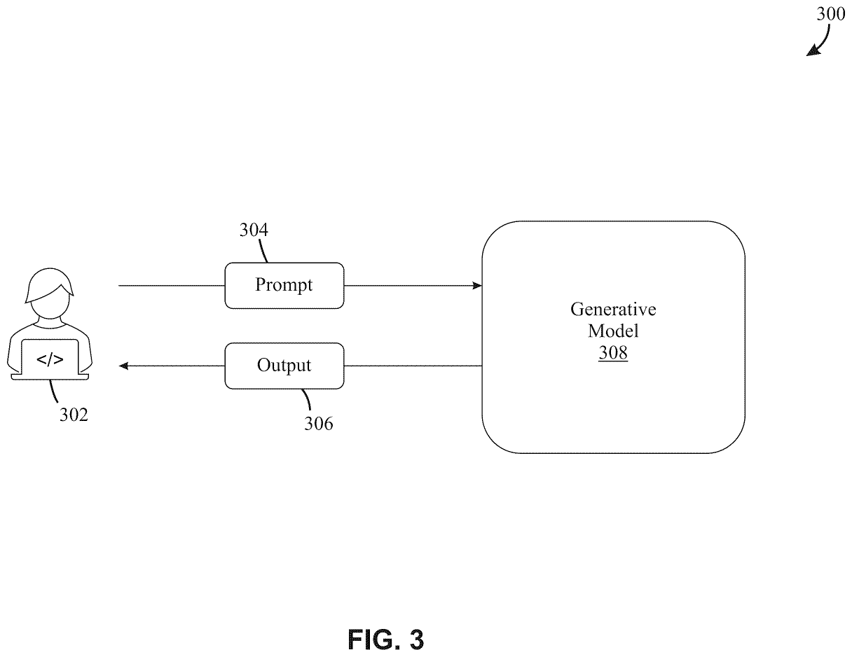

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

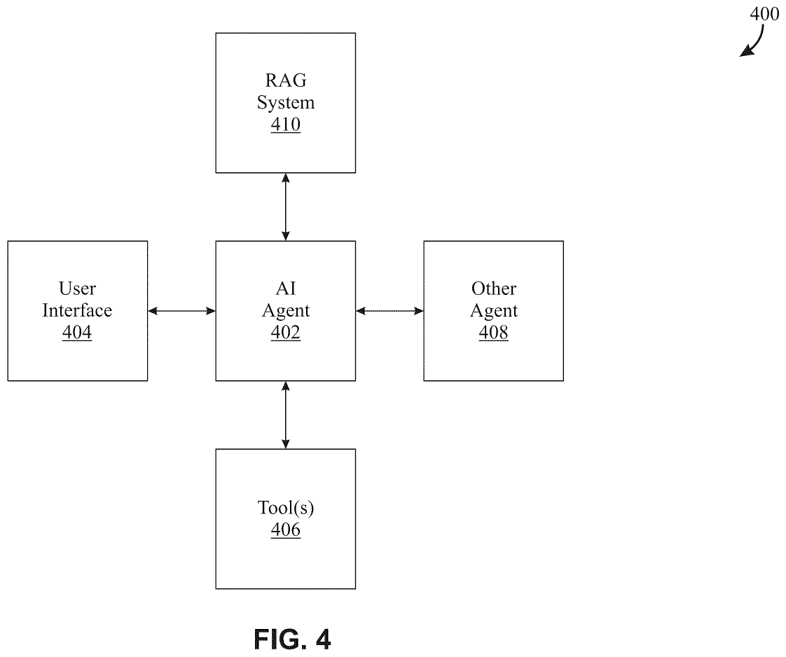

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, current agentic systems that rely on AI-based agents (e.g., those that use LLMs, etc.) demonstrate impressive problem-solving capabilities through multi-step reasoning and research. However, AI models such as LLMs are also stateless and lack learning abilities. This means they cannot utilize past experiences to improve their present and future performance. As a result, they repetitively undergo the same lengthy processes for solving similar problems. To address this, modern approaches rely on using supervised fine-tuning or reinforcement learning to learn specific question-solution pairs, thereby allowing the model to generate direct answers to those questions. While this can be effective for tasks with clear rules, it also 1.) reduces the ability of the model to generalize to new situations, 2.) has a high resource consumption due to its complexity (e.g., in terms of time, computing resources, etc.), 3.) requires large amounts of training examples, and 4.) risks catastrophic forgetting whereby the model forgets previously learned knowledge when new data is introduced.

### Learning Capable AI Agents

The techniques herein introduce an architecture that allows AI-based agents to improve their performance over time. In some aspects, the techniques herein may do so through the performance of agent-executed distillation steps that exact insights from the experiences of the agentic system over time.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device distills raw data regarding a past experience of an agentic system completing a first task into distilled experience data, the agentic system comprising a plurality of artificial intelligence-based agents that cooperated to complete the first task. The device receives a request for the agentic system to perform a second task. The device retrieves the distilled experience data and the raw data regarding the past experience in part by performing a matching of the second task to the distilled experience data. The device provides the distilled experience data and the raw data regarding the past experience to the agentic system for use to complete the second task.

Operationally, the techniques herein introduce the idea of learning-capable agents, which can remember and reuse successful strategies from past experiences. This allows them to make more efficient decisions, avoiding the need for repeated, complex reasoning processes. In various implementations, the techniques herein introduce the following:
1.) A mechanism to “distill” past data to learn key information from a small set of examples, remembering important details, and applying this knowledge to new problems.
2.) A mechanism to allow AI agents to first identify meaningful, past data and then learn from that data. By remembering successful strategies, these agents can make faster, better decisions, thereby improving efficiency and accuracy over time, and mitigating the risk of catastrophically forgetting important lessons.

These capabilities allow the agentic system to make quicker, more informed, and more deterministic decisions, reducing the need for repetitive, complex reasoning processes and thereby cutting down on time and resource consumption. By leveraging distilled knowledge from previous interactions, these agents can adapt to new tasks with minimal examples (dozens to hundreds), addressing the issue of catastrophic forgetting and ensuring continuous improvement.

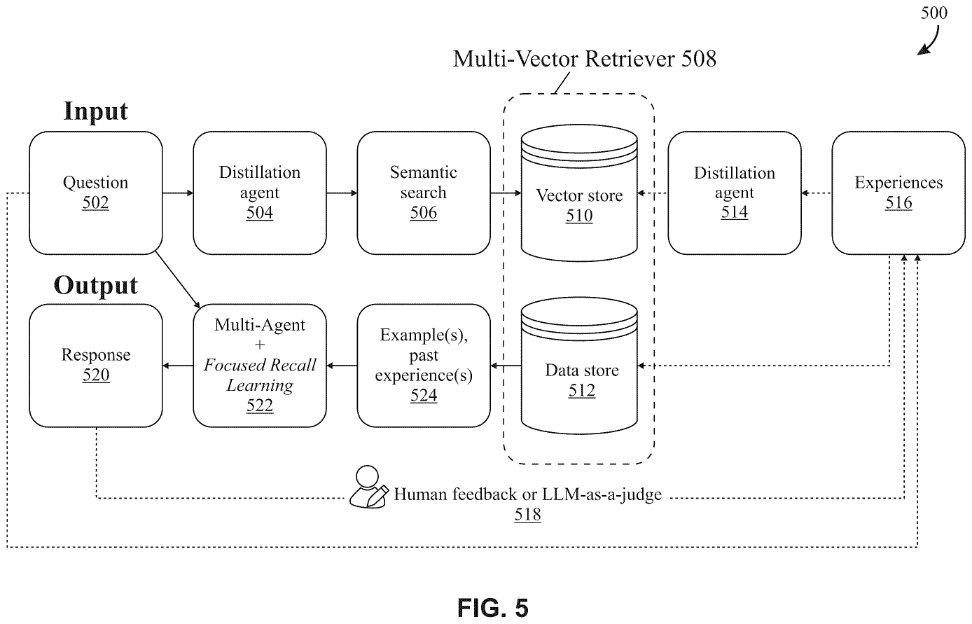

In various implementations, FIG. 5 illustrates an example architecture 500 for learning capable AI agents. As shown, the agentic system may store its past experiences, documents, and/or other relevant data in a multi-vector retriever 508. In general, multi-vector retriever 508 is designed to enhance retrieval-augmented generation (RAG) by differentiating between documents used for generating answers and those used for retrieval purposes. For illustrative purposes, the solid arrows in FIG. 5 indicate the events leading up to the final response, while the dashed arrows show what happens after the event.

Architecture 500 may also include one or more distillation agents, such as distillation agent 504 and distillation agent 514, in various implementations. In general, a distillation agent is configured to extract and refine key information from raw documents, experiences, etc. The goal of this is to identify and summarize the most pertinent details and store them in a searchable database of multi-vector retriever 508. In some implementations, the distillation agent may store condensed versions of this information in an optimized way for vector-based similarity searches within a vector store 510 of multi-vector retriever 508. Similarly, the full information is stored in a corresponding data store 512 associated with multi-vector retriever 508 and accessible by an LLM or other AI model for analysis. By storing both the condensed and raw information, this ensures that no context is lost during the answer synthesis process.

For instance, assume that the agentic system encounters experiences 516 over the course of its operations. Experiences 516 could broadly include any of the documents that it encounters when processing a given prompt, the prompt itself, its response to the prompt, and/or any criticisms or other forms of feedback 518 from a human user or LLM-as-a-judge mechanism regarding the response. In various implementations, the agentic system may store the raw information regarding experiences 516 within corresponding data store 512. In addition, distillation agent 514 may use its AI model to formulate condensed/distilled representations of experiences 516 in the form of vector representations that it stores in vector store 510.

When the system receives an input prompt/question 502, distillation agent 504 may reformulate or rewrite it for enhanced clarity and relevance. In turn, the system may perform a semantic search 506 using the updated input via multi-vector retriever 508 (e.g., using a vectorized form of the input with respect to vector store 510). Consequently, multi-vector retriever 508 may fetch those past examples and experiences 524 that are relevant to the input, based on its similarity to the stored summaries.

In various implementations, a multi-agent component 522 may use what is referred to herein as ‘focused recall learning’ to process experiences 524. More specifically, multi-agent component 522 may include one or more agents with advanced reasoning capabilities that take as input experiences 524 and question 502 with the goal of extracting valuable insights and patterns. This analysis will typically identify key features and relationships that aid in understanding the current task and generating appropriate responses.

The response 520 that multi-agent component 522 generates can then be provided back to the requester. In addition, the system may also store response 520, its corresponding question 502, and/or any other information regarding them as a new experience as part of experiences 516. In one implementation, the system may also associate feedback 518 with response 520, as described above. Indeed, user feedback or LLM-as-a-judge scoring can be optionally employed to assess the quality of the solutions, indicating their usefulness for future reference.

In turn, distillation agent 514 indexes the new experience and stores it in vector store 510 (e.g., as embedding vectors) and corresponding data store 512 within multi-vector retriever 508. This process then repeats for the next input question.

Here, the design of a learning capable agentic system involves the following:
1. Distillation Mechanism: extracts key information from past experiences, focusing on successful outcomes. In addition, distilled experiences are stored in a vector database, while full experiences go into a document store.
2. Multi-Vector Retriever: recalls relevant past experiences for new situations using semantic search and document store search. In some implementations, the retriever may also decouple the entire experiences from their distilled versions, storing them separately.
3. Focused Recall Learning: reuses contextually relevant past solutions by assessing their applicability to new problems.

By analogy, the design of the learning-capable LLM agents parallels the human brain's functioning in several ways. This analogy can be broken down into a few key points:
Experience Storage and Retrieval: just as the human brain stores a library of experiences in the right hemisphere and recalls relevant past experiences through the left hemisphere's pattern matching, the learning-capable LLM agents use a Multi-Vector Retriever to store and recall key information from past interactions. This mechanism ensures that the agent can access and apply relevant past solutions to new problems efficiently.
Contextual Learning and Decision-Making: The agent's ability to distill and apply past solutions to new problems mirrors the left brain's analysis and decision-making based on the right brain's stored experiences. This process, akin to the agent's “Focused Recall Learning”, allows the agent to evaluate the relevance and applicability of past experiences to address current tasks, enhancing its reasoning capabilities.
Memory Recall for Improved Efficiency: The agent's design includes a memory recall step that ensures it checks for similar past problems before proceeding, much like the human brain consults past experiences to inform decision-making. Over time, this leads to quicker and higher-quality responses, demonstrating the agent's ability to learn from experience and improve efficiency, similar to the human brain's reliance on accumulated experiences.

As would be appreciated, a distillation agent is an important component in the framework for learning-capable LLM agents and enhances the efficiency and effectiveness of information retrieval and application. By extracting and refining key information from raw documents and past experiences, the distillation agent creates summarized versions optimized for vector-based similarity searches. This distilled information is stored in a vector database, ensuring that the full context remains available to the LLM for answer synthesis while simultaneously improving retrieval efficiency. This process not only preserves the lessons learned from past interactions but also enables the agents to quickly access and apply relevant knowledge to new problems, thereby reducing the need for repetitive, complex reasoning processes. The distillation agent's ability to handle multimodal data further extends its utility, making it a versatile tool for improving the performance and adaptability of LLM agents across various use cases.

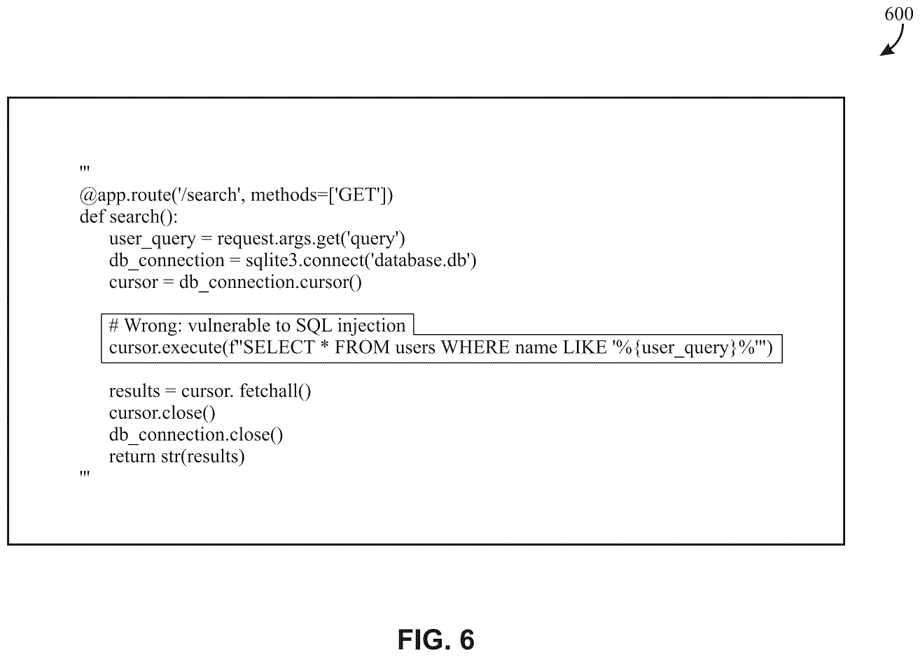

By way of example, consider the code snippet 600 in FIG. 6. Given code snippet 600, the agentic system could ask its distillation agent to call out certain characteristics of the code in its summary of the code. Such characteristics may include, for instance, PEP 8 compliance, code quality, code functionality, performance, scalability and maintainability, compatibility (along with dependencies), security, or version control. With respect to the SQL code highlighted in code snippet 600, the distillation agent may output the following:
“The function search( ) handles GET requests to search for users in a database based on a query parameter. It returns the search result as a string.
1. Security: Critical—the initial code is vulnerable to SQL injection; correct by using parameterized queries.
2. Code quality: High-improved by preventing SQL injection.
3. Compatibility: Medium-Relies on SQLite and Flask.”

In turn, the distillation agent (e.g., distillation agent 514) may store the above output for semantic search in a (e.g., vector store 510) and the original function will be stored into the data store (e.g., data store 512). Note that key information extracted from the original code, e.g., an entity-rich summary of the code, where each entity (in the example “security”, “code functionality” and “compatibility”) provides a short description and level of severity.

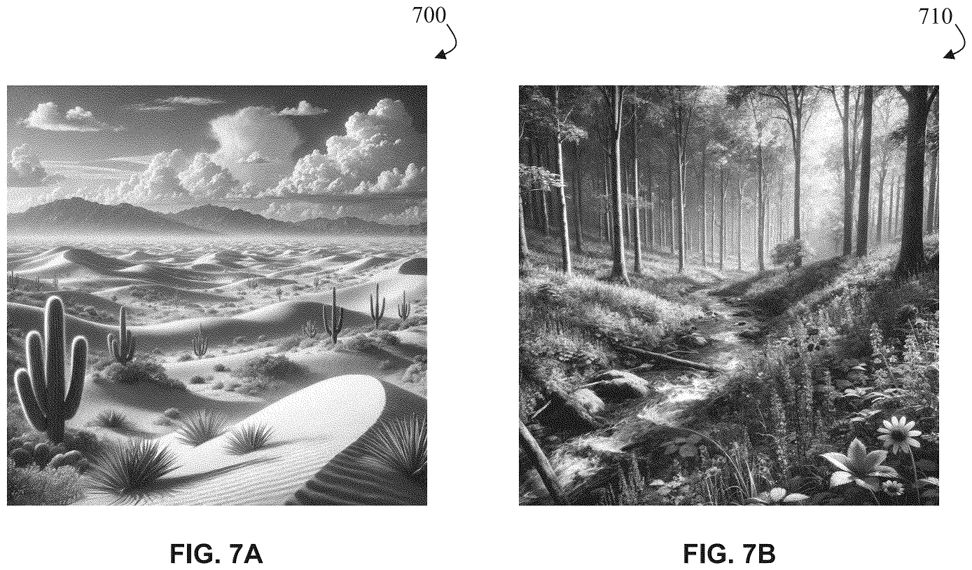

In the case of multimodal data (e.g., a combination of text and audio/video, etc.), the distillation agent could likewise assess the underlying characteristics of the media. For instance, consider the case of developing an agent to seek images of natural landscapes, such as a desert and a forest. An example image 700 is shown in FIG. 7A of such a desert and an example image 710 is shown in FIG. 7B of such a forest.

Though these images are visually different at first glance, the task is to identify their underlying similarities and core features, i.e. the characteristics previously discussed. For the desert in image 700, it emphasizes vast open spaces, sand dunes, and a warm color palette. However, for the forest in image 710, it highlights dense vegetation, tree canopies, and a cooler color palette, which encapsulate the core characteristics of each image. In such a case, the distillation agent may identify the underlying similarities and differences between the two images within the context of “natural landscapes” or “ecosystems, despite their vastly different visual appearances.

Here, the distillation agent may identify image 700 as having the following characteristics: a vast, open natural landscape characterized by its expansive, sandy terrain and sparse vegetation, embodying the essence of a serene ecosystem. Similarly, the distillation agent may identify the following characteristics of image 710: a lush, open natural landscape filled with dense trees and rich biodiversity, representing the tranquility and complexity of a thriving ecosystem.

Few-shot learning offers remarkable flexibility and efficiency, allowing LLMs to adapt quickly to new tasks with minimal examples. However, selecting the right examples that accurately represent the task can be challenging. In some instances, the focused recall learning herein may expand this concept via contextual examples. More specifically, it may leverage the current conversation context or input query to fetch at the runtime examples that are directly relevant to the input query. This ensures that the examples are timely and pertinent to the current topic.

Another challenge is in determining which information to extract from the examples, how to organize it and distill such information into experiences. To address this, the techniques herein may analyze each example to extract relevant patterns and apply this distilled knowledge to new tasks efficiently.

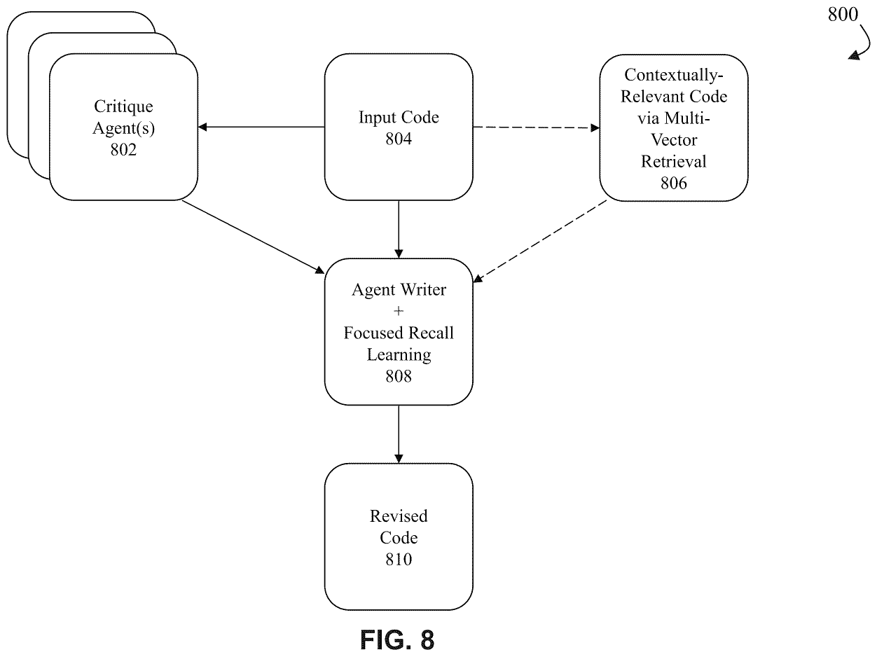

By way of example, FIG. 8 illustrates an example architecture 800 for code generation and review using the focused recall learning introduced herein, according to various implementations. As shown, assume that there one or more critique agents 802 configured to provide feedback on input code 804. An agent writer 808 can take the critiques of input code 804, as well as input code 804 itself, to produce revised code 810.

To enhance the functioning of the system, the techniques herein enhance agent writer 808 to also use focused recall learning when revising input code 804. To do so, the system may also include a distillation mechanism that allows it to perform a retrieval 806 of any contextually-relevant code for input code 804, such as via multi-vector retrieval. Such contextually-relevant code could include, for instance, previously generated or used code, any feedback regarding the code, etc. This addition allows the system to utilize past experiences and enhance the learning capabilities of its agents, thereby improving efficiency and performance.

Here, agent writer 808 may use focused recall learning to enhance the learning capabilities of existing LLM agents by leveraging principles akin to object-oriented programming. This agent functions as an extendable class, designed to augment the intrinsic abilities of LLMs through a structured and modular approach. In addition, it may also incorporate a Distillation Agent to extract and refine key information from past experiences, a Focused Recall Learning prompt to ensure the retrieval of contextually relevant examples, and a Multi-Vector Retriever to efficiently store and access distilled knowledge, in accordance with the techniques herein.

By organizing these components into a cohesive framework, agent writer 808 allows LLMs to recall and apply pertinent past solutions to new problems, thereby improving their efficiency and performance across a wide range of tasks. This class-oriented design not only facilitates the integration of advanced reasoning capabilities into existing systems but also ensures that the agents can continuously learn and adapt, mirroring the dynamic nature of human learning and decision-making processes.

To illustrate the effectiveness of the techniques herein, two sample cases are presented. The first case focuses on synthetic data generation, showcasing how the framework herein performs when generating high-quality synthetic reviews. The second case delves into function generation/review, illustrating the framework's capability to generate accurate and contextually relevant functions based on past experiences.

For the first use case, Table 1 below shows a comparative analysis of the quality of synthetically generated data by our proposed framework versus other available approaches using the Amazon reviews' dataset. The “GPT-4o” case refers to a standalone LLM with a prompt tailored to text generation, while the “GPT-4o+focused learning” case refers to the application of the learning capable agent framework herein.

Given an input title (e.g. “Great product!”) and an Amazon rating (on a scale of 1-5), synthetically generated reviews were generated for beauty products purchased online on Amazon.com. The dataset utilized is the McAuley-Lab/Amazon-Reviews-2023 dataset with scores on a scale of 1-10 with their associated errors, and calculated by comparing the generated reviews to the ground truth from the above dataset.

TABLE 1

| Amazon | GPT = 4O + Focused | GPT-4O | Gretel.AI |
|---|---|---|---|
| Ratings | Learning Score | Score | Score |
| 1 | 5.6 +/− 0.07 | 4.3 +/− 0.1 | 3.5 +/− 0.09 |
| 2 | 6 +/− 0.03 | 4.7 +/− 0.08 | 3.7 +/− 0.09 |
| 3 | 7 +/− 0.04 | 5.5 +/− 0.05 | 4.9 +/− 0.07 |
| 4 | 6 +/− 0.1 | 4.5 +/− 0.08 | 4.1 +/− 0.07 |
| 5 | 7.9 +/− 0.05 | 6.6 +/− 0.06 | 6.4 +/− 0.09 |

For the second use case, code snippet 600 shown in FIG. 6 was used as input. As would be appreciated, code snippet 600 includes a function that handles a GET request to search the “users” table in an SQLite database based on the user's query. It also contains a SQL injection vulnerability due to directly interpolating the user input into the SQL query and other security issues (highlighted in FIG. 6).

To perform testing the LLM agents were asked to re-write the initial function by fixing the above security issues. The results were then evaluated across multiple criteria, namely PEP 8 compliance, code quality, code functionality, performance, scalability and maintainability, compatibility, dependencies, and security. The results are shown below 10 in Table 2 below. Scores are on a scale of 1-10 with their associated errors.

TABLE 2

| | GPT = | | Original |
|---|---|---|---|
| | 4O + Focused | GPT-4O | Code |
| Rubric | Learning Score | Score | Score |
| PEP 8 Compliance | 9.5 +/− 0.18 | 9.65 +/− 0.13 | 7.75 +/− 0.2 |
| Code Quality | 7.95 +/− 0.11 | 8.2 +/− 0.13 | 6.4 +/− 0.18 |
| Performance | 5.25 +/− 0.18 | 5.5 +/− 0.05 | 4.9 +/− 0.07 |
| Scalability and | 7.6 +/− 0.11 | 4.8 +/− 0.14 | 3.6 +/− 0.13 |
| Maintainability | | | |
| Compatibility, | 7.25 +/− 0.16 | 4.1 +/− 0.2 | 2.85 +/− 0.28 |
| Dependencies, and | | | |
| Security | | | |

Note that in Table 2 the quality of code generated by the framework herein consistently surpasses that of GPT-40 (standalone LLM) around “compatibility, dependencies, and security,” as the initial code was affected primarily by security issues and “Scalability and maintainability,” showing its efficacy.

In summary, the techniques herein introduce a mechanism for AI agents to learn from experiences. Enhancing such agents with the ability to learn from past actions can increase their efficiency and accuracy over time. By remembering successful strategies, these agents can make quicker, better decisions, reducing the time and resources needed.

The techniques herein may also store whole interactions/experiences and their distilled version for future use into the multi-vector store, preserving the lessons learned. This allows the agents to remember what has worked in the past, and thus to effectively learn from experience.

The techniques herein can further distill past interactions and data into meaningful experiences. An agent can analyze examples to extract relevant patterns and apply this distilled knowledge to new tasks efficiently.

Distilled past interactions and data lead to an improvement of the quality of the downstream task of an agentic solution. For instance, preliminary testing has shown that that the final code in a code generation use case is up to 70% better in term of score across multiple rubrics (code quality, code functionality, security etc.), compared to code generated without leveraging the techniques herein.

Further aspects of the techniques herein introduce a multi-vector store solution, where a summarized version of the interaction, created by a distillation agent, is optimized for vector-based similarity searches. At the same time, the full document or past interactions are still provided to the LLM or other AI model. This approach significantly enhances the ability to fetch relevant past interactions.

Additionally, the techniques herein make these agents more helpful but also cut down on the time and resources needed to get the right outcomes up to 90%. Thus, a large quantity of high quality, question-solution pairs are not required for purposes of model fine-tuning to generate answers directly from queries. In contrast, the techniques herein can operate on only a handful of examples.

In summary, the techniques herein introduce an architecture and methodology that relies on two distillation steps, each one potentially being performed by a different agent. The first distillation decouples the entire experiences, which the system uses for answer synthesis, from their “distilled” version (a streamlined, efficient version that focuses on the core insights of experiences), which the system uses for retrieving such experiences. This step is “task-independent” and is concerned with how the system retrieves past experiences and identifying which experience or experiences are relevant for the task at hand.

In the second distillation, another agent distills past full and relevant experiences. The result of this distillation is a set of key information extracted from the whole experiences, allowing the system to then apply this knowledge to a new task. This step is “task-dependent” and is about learning.

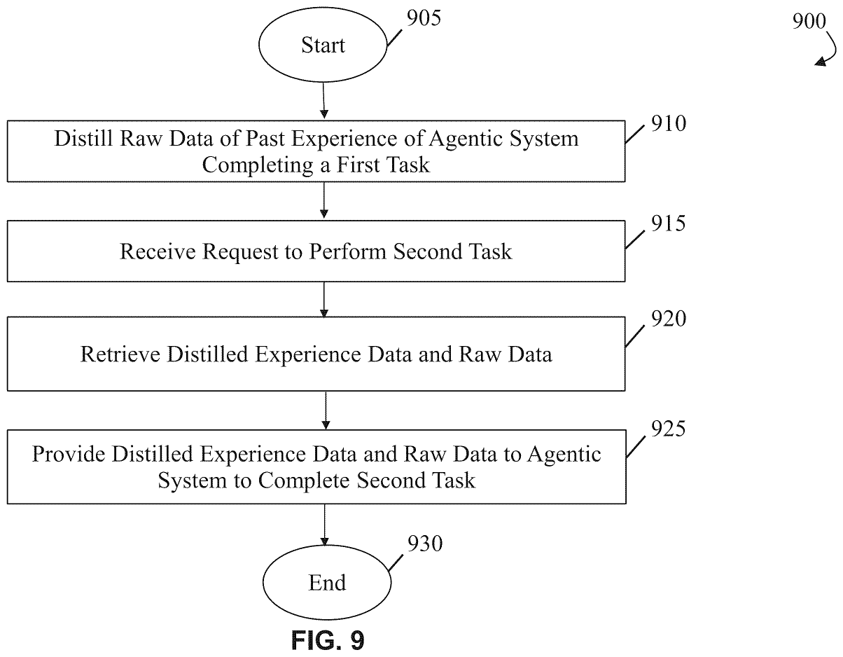

FIG. 9 illustrates an example simplified procedure for using learning capable artificial intelligence (AI) agents, in accordance with one or more implementations described herein. For example, a non-generic, specifically configured device (e.g., device 200), may perform procedure 900 (e.g., a method) by executing stored instructions (e.g., AI process 248). The procedure 900 may start at step 905, and continues to step 910, where, as described in greater detail above, the device (e.g., a controller, server, etc.) may distill raw data regarding a past experience of an agentic system completing a first task into distilled experience data, the agentic system comprising a plurality of artificial intelligence-based agents that cooperated to complete the first task. In some implementations, the raw data regarding the past experience is based on user feedback regarding processing of the first task by the agentic system. In further implementations, the raw data regarding the past experience is based on feedback from an artificial intelligence-based judge regarding processing of the first task by the agentic system. In one implementation, the agentic system uses a multimodal artificial intelligence to complete the first task.

At step 915, as detailed above, the device may receive a request for the agentic system to perform a second task. In some instances, the first task and the second task are different tasks.

At step 920, the device may retrieve the distilled experience data and the raw data regarding the past experience in part by performing a matching of the second task to the distilled experience data, as described in greater detail above. In some implementations, the device may also store the distilled experience data in a vector database and store the raw data regarding the past experience in a separate database as an entry associated with the distilled experience data in the vector database. In such cases, the device may retrieve the raw data regarding the past experience in part by performing a search of the vector database using an encoding of the request, to match the request to the distilled experience data.

At step 925, as detailed above, the device may provide the distilled experience data and the raw data regarding the past experience to the agentic system for use to complete the second task. In some implementations, the plurality of artificial intelligence-based agents uses at least one large language model to complete the second task. According to various implementations, the agentic system uses focused recall learning on raw experience data to complete the second task. In one implementation, the agentic system completes the second task by writing code.

Procedure 900 may then end at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for learning capable artificial intelligence agents, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
distilling, by a device, raw data regarding a past experience of an agentic system completing a first task into distilled experience data, the agentic system comprising a plurality of artificial intelligence-based agents that cooperated to complete the first task;
receiving, at the device, a request for the agentic system to perform a second task;
retrieving, by the device, the distilled experience data and the raw data regarding the past experience in part by performing a matching of the second task to the distilled experience data; and
providing, by the device, the distilled experience data and the raw data regarding the past experience to the agentic system for use to complete the second task.

2. The method as in claim 1, wherein the plurality of artificial intelligence-based agents uses at least one large language model to complete the second task.

3. The method as in claim 1, wherein the raw data regarding the past experience is based on user feedback regarding processing of the first task by the agentic system.

4. The method as in claim 1, wherein the raw data regarding the past experience is based on feedback from an artificial intelligence-based judge regarding processing of the first task by the agentic system.

5. The method as in claim 1, further comprising:
storing, by the device, the distilled experience data in a vector database; and storing the raw data regarding the past experience in a separate database as an entry associated with the distilled experience data in the vector database.

6. The method as in claim 5, wherein the device retrieves the raw data regarding the past experience in part by:
performing a search of the vector database using an encoding of the request, to match the request to the distilled experience data.

7. The method as in claim 1, wherein the agentic system uses focused recall learning on raw experience data to complete the second task.

8. The method as in claim 1, wherein the first task and the second task are different tasks.

9. The method as in claim 1, wherein the agentic system completes the second task by writing code.

10. The method as in claim 1, wherein the agentic system uses a multimodal artificial intelligence to complete the first task.

11. An apparatus, comprising:
one or more network interfaces;
a processor coupled to the one or more network interfaces and configured to execute one or more processes; and
a memory configured to store a process that is executable by the processor, the process when executed configured to:
distill raw data regarding a past experience of an agentic system completing a first task into distilled experience data, the agentic system comprising a plurality of artificial intelligence-based agents that cooperated to complete the first task;
receive a request for the agentic system to perform a second task;
retrieve the distilled experience data and the raw data regarding the past experience in part by performing a matching of the second task to the distilled experience data; and
provide the distilled experience data and the raw data regarding the past experience to the agentic system for use to complete the second task.

12. The apparatus as in claim 11, wherein the plurality of artificial intelligence-based agents uses at least one large language model to complete the second task.

13. The apparatus as in claim 11, wherein the raw data regarding the past experience is based on user feedback regarding processing of the first task by the agentic system.

14. The apparatus as in claim 11, wherein the raw data regarding the past experience is based on feedback from an artificial intelligence-based judge regarding processing of the first task by the agentic system.

15. The apparatus as in claim 11, wherein the process when executed is further configured to:
store the distilled experience data in a vector database; and storing the raw data regarding the past experience in a separate database as an entry associated with the distilled experience data in the vector database.

16. The apparatus as in claim 15, wherein the apparatus retrieves the raw data regarding the past experience in part by:
performing a search of the vector database using an encoding of the request, to match the request to the distilled experience data.

17. The apparatus as in claim 11, wherein the agentic system uses focused recall learning on raw experience data to complete the second task.

18. The apparatus as in claim 11, wherein the first task and the second task are different tasks.

19. The apparatus as in claim 11, wherein the agentic system uses a multimodal artificial intelligence to complete the first task.

20. A tangible, non-transitory, computer-readable medium storing program instructions that cause a device to execute a process comprising:
distilling, by the device, raw data regarding a past experience of an agentic system completing a first task into distilled experience data, the agentic system comprising a plurality of artificial intelligence-based agents that cooperated to complete the first task;
receiving, at the device, a request for the agentic system to perform a second task;
retrieving, by the device, the distilled experience data and the raw data regarding the past experience in part by performing a matching of the second task to the distilled experience data; and
providing, by the device, the distilled experience data and the raw data regarding the past experience to the agentic system for use to complete the second task.
